(19) United States
(12) Patent Application Publication
(10) Pub. No.: US 2009/0107346 A1
(43) Pub. Date: Apr. 30, 2009

(54) SOLAR ENERGY DRIVING ROTARY ROASTING ROD DEVICE

(76) Inventor: William Home, Taipei (TW)

Correspondence Address: LEONG C LEI, PMB # 1008, 1867 YGNACIO VALLEY ROAD, WALNUT CREEK, CA, 94598, US

(21) Appl. No.: 11/877,690

(22) Filed: Oct. 24, 2007

(51) Int. Cl. A47J 37/04

(52) U.S. Cl. 99/421 R

(57) ABSTRACT

A solar energy driving rotary roasting rod device is selectively mounted to a barbecue device with a roasting rod extending across the barbecue device. The roasting device includes an upright housing from which the roasting rod extending transversely. The housing has a top to which an elevation bar forming a direction-changeable joint is mounted in an extendable manner. The direction-changeable joint mounts a light reaction casing in a rotatable manner. The housing forms an interior space receiving an electromechanical driving device, a control circuit including an actuation switch, and a rechargeable power storage device, which are electrically connected to a solar panel formed on a top face of the casing and a lighting device comprised of light-emitting diodes mounted to a side face of the casing. The electromechanical driving device has a power output socket that is exposed to receive and couple the roasting rod.

### BACKGROUND OF THE INVENTION

(a) Technical Field of the Invention

The present invention relates to a solar energy rotating roasting device, which is attachable to an outdoor barbecue device to allow rotary roasting rod extending across a top of the barbecue device so that the barbecue device is added with an automatic rotatable roasting rod that is driven by solar energy together with solar energy based lighting and power supply arrangement.

(b) Description of the Prior Art

Foods secured to a spindle of an electrical motor to use the motor spindle as a roasting rod for roasting the food is commonly known, which uses the motor to rotate the food secured to the roasting rod in order to uniformly heating and conveniently roast the food. Although this is commonly used, driving the roasting rod with a motor requires a supply of electrical power to the motor. One solution for such a problem is to power the motor with electrical main. This, however, imposes a limitation to the site where the roasting device can be used. For indoor operation, the supply of power from the electrical main is readily available, but for outdoor use, it is certainly problematic to establish electrical connection of the roasting device and the electrical main.

A roasting device that is driven by a DC motor powered by for example storage battery is also available, which is particularly suitable for outdoor use. However, the storage battery must be accompanying the roasting device in order to drive the motor. This is to some extents inconvenient for outdoor use of the roasting device at a remote site. Further, the power supplied by the storage battery is limited, which impose further limitation to outdoor use of the roasting device.

Thus, it is desired to provide a solar energy driving rotary roasting rod device that overcomes the above discussed problems associated with the conventional devices.

### SUMMARY OF THE INVENTION

The primary purpose of the present invention is to provide a solar energy driving rotary roasting rod device, comprising an upright housing to which a transversely extending roasting rod is mounted. The housing as a top to which an elevation bar is extendably mounted and forming a direction-changeable joint for mounting a light reaction casing in a rotatable manner. The housing forms an interior space receiving an electro-mechanical driving device, a control circuit including an actuation switch, and a rechargeable power storage device, which are electrically connected to a solar panel formed on a top face of the casing and a lighting device comprised of light-emitting diodes mounted to a side face of the casing. The electro-mechanical driving device has a power output socket that is exposed through a side face of the housing for receiving and coupling the roasting rod. As such, the solar panel can be selectively oriented toward sunlight to collect and convert the solar energy into low-voltage DC power for storage and subsequent use in the driving of automatic rotation of roasting rod, lighting, and external power supply. Thus, concerns for the availability of external power source and supplementing of consumed power are removed and environmental conservation is also realized.

The solar energy driving rotary roasting rod device in accordance with the present invention has a compact configuration for ready and convenient portability and the solar panel used in the rotary roasting rod device is also of a limited size, which provides for example a voltage of 3V, which is sufficient to power a 3V DC motor constituting the electromechanical driving device but eliminating the risk of high voltage electrical shock to a user. The DC motor is driven by the solar panel used in the present invention to generate a 0.2 Kg driving force that is converted by the reduction transmission system to increase the driving force to 20 Kg, which is sufficient to drive the roasting rod with normal load. With such an arrangement, even though a user inadvertently touch the power supply route and gets electrically shocked, the 3V low voltage direct current hardly causes any harm to the human body so that operation safety is ensured.

Further, in the solar energy driving rotary roasting rod device in accordance with the present invention, besides being used to power the 3V DC motor included in the electromechanical driving device, the electrical power obtained by converting the solar energy collected by the solar panel can be additionally accumulated in a power storage device, such as a rechargeable battery, for finer use, including powering a lighting device constituted by light-emitting diodes and supplying power to external electrical appliance, such as a radio, which is releasably connected to the rotary roasting rod device. Thus, a multi-purpose device can be realized.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a solar energy driving rotary roasting rod device constructed in accordance with the present invention;

FIG. 2 is a perspective view of the solar energy driving rotary roasting rod device in accordance with the present invention in a stowed condition;

FIG. 3 is a perspective view similar to FIG. 2 but showing a modified embodiment of the solar energy driving rotary roasting rod device in accordance with the present invention;

FIG. 4 is a perspective view of the solar energy driving rotary roasting rod device of the present invention in an extended, operation condition;

FIG. 5 is similar to FIG. 4 but showing the solar energy driving rotary roasting rod device of the present invention in another operation condition;

FIG. 6 is similar to FIGS. 4 and 5, but showing the solar energy driving rotary roasting rod device of the present invention in a further operation condition; and

FIG. 7 is a side elevational view schematically illustrating an application of the solar energy driving rotary roasting rod device mounted to a barbecue device.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

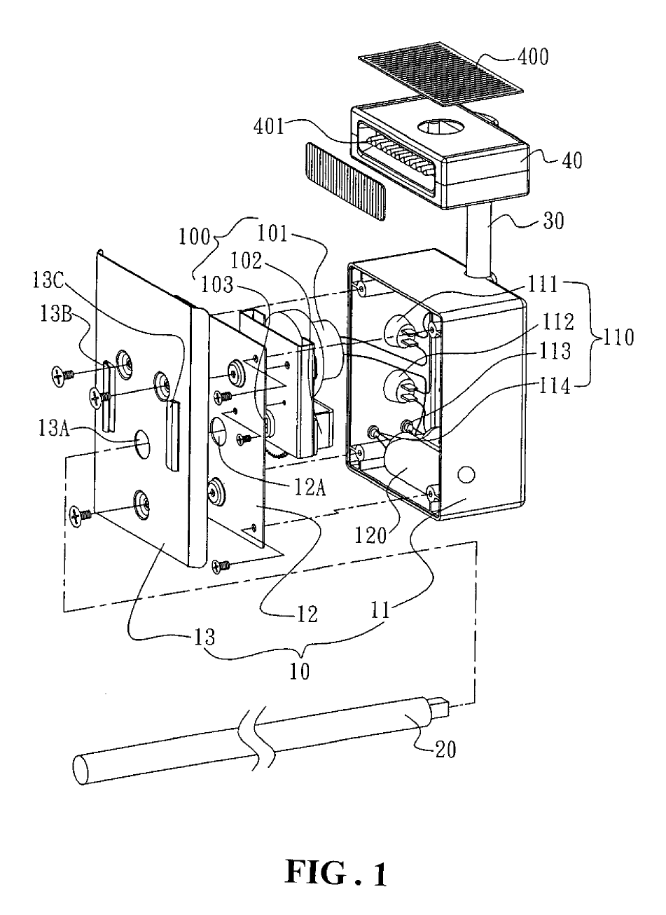

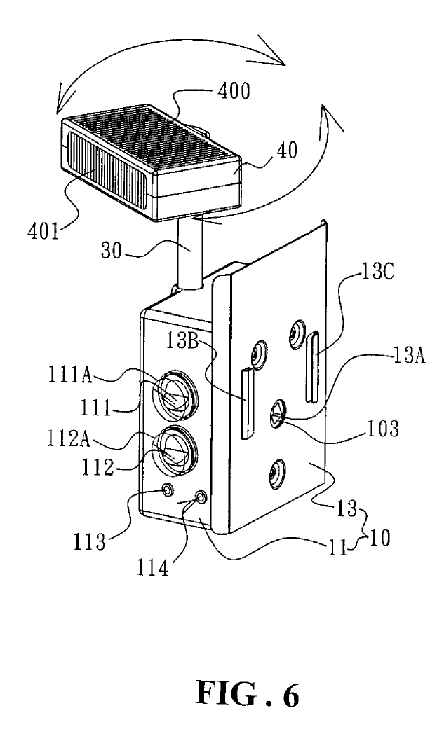

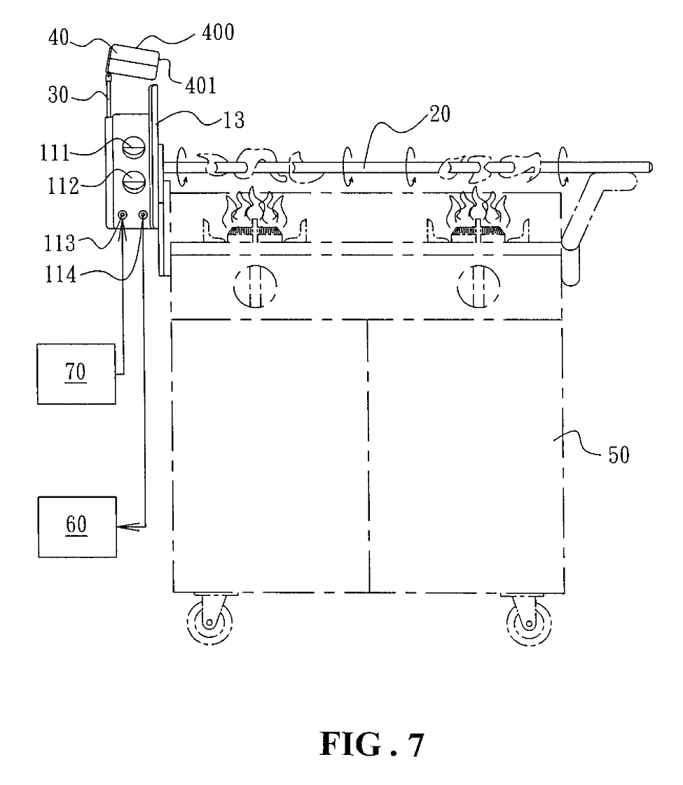

With reference to the drawings and in particular to FIG. 1, a solar energy driving rotary roasting rod device constructed in accordance with the present invention is illustrated. The rotary roasting rod device of the present invention comprises an upright housing 10 having a side face to which a roasting rod 20 is mounted and transversely extends. An elevation bar 30 is mounted to and extends upright from a top of the housing 10 and has a top free end forming a direction-changeable joint 31 that carries and mounts a light reaction casing 40. The housing 10 forms an interior space in which an electromechanical driving device 100, a control circuit 110 including an actuation switch 112, and a rechargeable power storage device 120 are accommodated in such a way to be electrically connected to a solar panel 400 arranged on a top face of the casing 40 and a lighting device comprised of light-emitting diodes 401 arranged on a side face of the casing 40. The electromechanical driving device 100 comprises a 3V DC motor 101 having an output end coupled to a reduction transmission system 102. The reduction transmission system 102 forms, at an output side thereof, a power output socket 103 exposed through the side face of the housing 10 to receive and operatively couple the roasting rod 20. Besides the actuation switch 112, the control circuit 110 also comprises a lighting switch 111, a charging connector 113, and a power supply connector 114, as well as rectification and filter circuit that process electrical power converted from solar energy for charging the rechargeable power storage device 120. If desired, protection caps 111A, 112A (FIG. 6) can be selectively and openably mounted to cover the lighting switch 111 and the actuation switch 112.

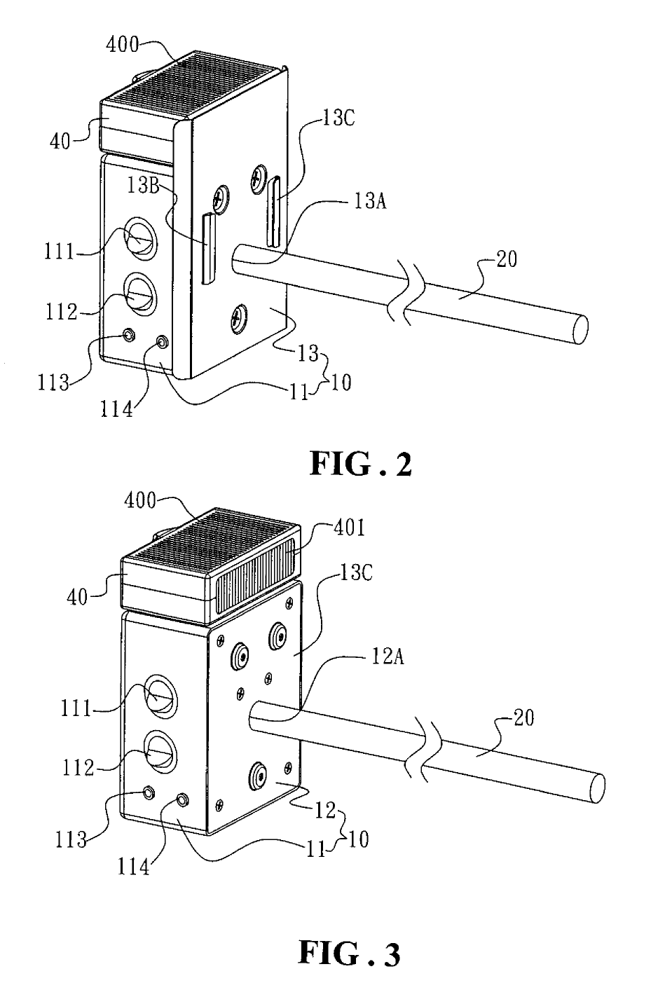

The housing 10, as shown, comprises an open-box like case 11 having an opening covered first by a primary lid 12 and further covered by a secondary panel 13. The case 11 is constructed to expose the actuation switch 112, the lighting switch 111, the charging connector 113 and the power supply connector 114. The primary lid 12 and the secondary panel 13 respectively form through holes 12A, 13A that align with the power output socket 103 to allow the power output socket 103 to be exposed to receive the roasting rod 20. On an outer surface of the secondary panel 13, which is opposite to the inner surface of the secondary panel 13 that covers the primary lid 12, raised portions (not labeled) are formed to define clamping slots 13B, 13C, which are engageable with and thus attached to a side wall of a regular outdoor barbecue device (see FIG. 7). The completely assembled rotary roasting rod device of the present invention is illustrated in a perspective view of FIG. 2, which is in a stowed condition. If desired, and as an alternative to the configuration shown in FIGS. 1 and 2, the secondary panel 13 can be removed, leaving only the primary lid 12 covering the opening of the case 11, as shown in FIG. 3.

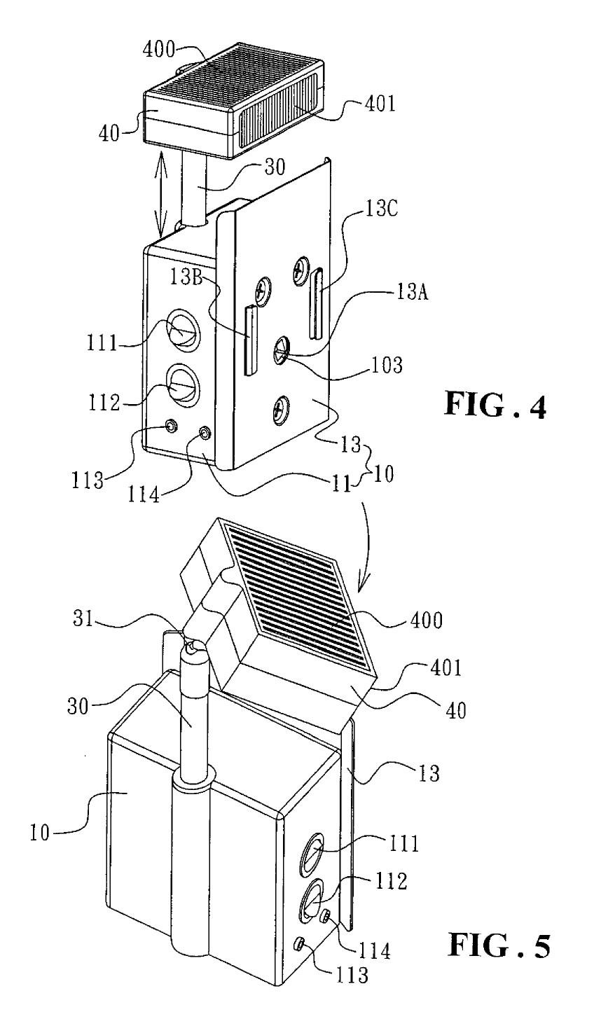

To operate, as shown in FIG. 4, the elevation bar 30, which is extendible from the stowed position shown in FIG. 2 to an extended position shown in FIG. 4, is raised to the extended position, which sets the solar panel 400 and the lighting device formed of the light-emitting diodes 401 of the case 40 at an elevated position. Once the case 40 is set at the elevated position, if desired, the case 40 can be rotated about the direction-changeable joint 31 to orient the case 40 to an inclined direction, where the solar panel 400 and the lighting device of the light-emitting diodes 401 are inclined downward or upward corresponding to a desired orientation. Alternatively, the case 40 can be rotated about an axis concentric with the elevation bar 30 to have the solar panel 400 and the light-emitting diodes 401 directed to a desired orientation. In this way, the case 400 can be rotated in a full sphere manner to allow the solar panel 400 of the case 40 to orient toward sunlight for the optimum performance of collection of solar energy or to allow the lighting device of the light-emitting diodes 401 to radiate at any desired direction.

With such an arrangement, in a practical application as exempted in FIG. 7, the solar energy driving rotary roasting rod device of the present invention can be attached to the side wall of a barbecue device 50 with the roasting rod 20 extending across a top of the barbecue device 50 where fire or heat sources may be set to roast food secured on the roasting rod 20. The solar panel 400 is set at a desired orientation toward sunlight. Thus, in a sun-shining day or in the daytime when surrounding light is sufficient, the solar panel 400 collects the solar energy and converts the solar energy into low-voltage DC power for storage. Once the actuation switch 112 is activated, the roasting rod 20 is put into rotation to have the food secured thereon properly roasted. When it gets dark or when the surrounding light is insufficient, the lighting switch 111 can be actuated to make the lighting device of the light-emitting diodes 401 give off light. Further, an electrical appliance 60, such as a radio, can be plugged into the power supply connector 114 to receive electrical power from the rotary roasting rod device of the present invention. In case, the power level of the power storage device 120 is getting low, while sunlight is not intense enough to provide sufficient power to the power storage device 120, an external power source, such as an external storage battery 70, can be connected to the rotary roasting rod device of the present invention by means of the charging connector 113 to supplement electrical power to the power storage device 120.

To conclude, the solar energy driving rotary roasting rod device of the present invention functions to convert solar energy into low-voltage DC electrical power that is stored in the power storage device for subsequent use in rotating the roasting rod for roasting food, lighting, and external use to eliminate the risk of electrical shock caused by high voltage electrical power.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A solar energy driving rotary roasting rod device comprising an upright housing and a roasting rod movably coupled to the housing and extending transversely, the housing having a top to which an elevation bar forming a direction-changeable joint is mounted in an extendable manner, the direction-changeable joint mounting and supporting a light reaction casing in a rotatable manner, the housing forming an interior space receiving an electromechanical driving device, a control circuit comprising an actuation switch, and a rechargeable power storage device, which are electrically connected to a solar panel formed on a top face of the casing and a lighting device comprised of light-emitting diodes mounted to a side face of the casing, the electromechanical driving device comprising a power output socket that is exposed through a side face of the housing to receive and couple the roasting rod.

2. The solar energy driving rotary roasting rod device as claimed in claim 1, wherein the electromechanical driving device comprises a motor having an output end coupled to a reduction transmission system, which has an output side forming the power output socket exposed through the side face of the housing for receiving and coupling the roasting rod.

3. The solar energy driving rotary roasting rod device as claimed in claim 1, wherein, besides the actuation switch, the control circuit further comprises a lighting switch, a charging connector, a power supply connector, and rectification and filter circuits, and wherein the rectification and filter circuits process electrical power generated by conversion of solar energy to charge the electrical power to the power storage device.

4. The solar energy driving rotary roasting rod device as claimed in claim 3, wherein the housing comprises an open case having an opening which is firstly covered by a primary lid and further covered by a secondary panel; wherein the housing is constructed to expose the actuation switch, the lighting switch, the charging connector, and the power supply connector; and wherein the primary lid and the secondary panel respectively form through holes aligning the power output socket to expose the power output socket for receiving the roasting rod, the secondary panel forming clamping slots that are formed in a raised manner on a face of the secondary panel that is opposite to the primary lid.

5. The solar energy driving rotary roasting rod device as claimed in claim 3, wherein the housing comprises an open case having an opening which is firstly covered by a lid; wherein the housing is constructed to expose the actuation switch, the lighting switch, the charging connector, and the power supply connector; and wherein the lid forms a through hole aligning the power output socket to expose the power output socket for receiving the roasting rod.
